(19) United States
(12) Patent Application Publication
(10) Pub. No.: US 2015/0143738 A1
(43) Pub. Date: May 28, 2015

(54) FISHING LURE

(71) Applicant: Angelo VIOLA, Oshawa (CA)

(72) Inventor: Angelo VIOLA, Oshawa (CA)

(21) Appl. No.: 14/548,367

(22) Filed: Nov. 20, 2014

(30) Foreign Application Priority Data
Nov. 26, 2013 (CA) 2834482

(51) Int. Cl. A01K 85/01; A01K 85/16

(52) U.S. Cl. CPC A01K 85/01; A01K 85/16
USPC 43/42.32; 43/42.45

(57) ABSTRACT

A buoyant fishing lure is adapted to be drawn along the surface of water. The lure is in the shape of a rodent or other small creature and has a body coated with fur and a tail composed of a strip of fur. The lure has protruding concave shaped ears. The fur and the ears cause water through which the lure travels to flow outwardly from the body and to cause turbulence in the water.

### FIELD OF THE INVENTION

This invention relates to fishing lures and more particularly to an artificial fishing lore which simulates a small rodent both in appearance and in movement through water.

### CROSS-REFERENCE TO RELATED PRIOR APPLICATION

This application claims priority pursuant to 35 USC 119 of Canadian application no. 2,834,482 filed in the Canadian Intellectual Property Office on Nov. 26, 2013 which application is incorporated herein by reference in its entirety.

### BACKGROUND OF THE INVENTION

Artificial fishing lures come in various shapes and sizes some of which are designed to simulate small animals, some to simulate insects and some which do not simulate anything in particular hut are designed to attract fish by movement, smell, noise and so on.

The fishing lure of my invention is designed to simulate a rodent such as a mouse or a chipmunk and is farther designed, as it is pulled through water, to move in a way which is characteristic of the rodent as it swims through water. My lure is buoyant and, as it is pulled through water, causes turbulence and leaves a trail of wash, bubbles and foam in lis wake. Moreover my lure has other features which, while optional, add to its attractiveness to fish. For example, it may be provided with a flexible tail which undulates and it may also be provided with ball bearings in a hollow space within its body for producing a rattling sound as it travels through water.

### SUMMARY OF THE INVENTION

The lure of my invention has the shape of a small rodent having a head at the upstream end of the lure, a body and a ball at the downstream end. Preferably the lure has an outer coat of fur which covers part or all of the body. The head has a pair of oppositely facing cheeks, eyes and a pair of ears. Each ear is provided with an outer margin which extends along an edge having a number segments. The first segment commences at a forehead of the rodent and extends down stream and laterally outwardly of the head to a second segment. The second segment corves toward a third segment which extends outwardly from the rodent's head and terminates at a fourth segment which extends beneath the head and connects with a fourth segment of the other ear.

The ears of the rodent are coocuvu throughout their length and scoop the water through which the lure travels and causes the water to flow outwardly from the ears with resulting turbulence of the water through which the lure travels and hubbies in the wash and wake of the lure.

### DESCRIPTION OF THE DRAWINGS

The lure of the invention is described with reference to the accompanying drawings in which:

FIG. 1 is an elevation of the lure;

FIG. 2 is apian view of the lure;

FIG. 3 is view of the underside of the lure.

FIG. 4 is an elevation of the lure covered with a coat of fur and provided with hooks;

FIG. 5 illustrates the direction of movement of water from the sides of the lure as it travels through water; and

FIG. 6 illustrates the direction of movement of water from the beneath the lure.

Like reference characters refer to like parts throughout the description of the drawings.

### DESCRIPTION OF PREFERRED EMBODIMENT

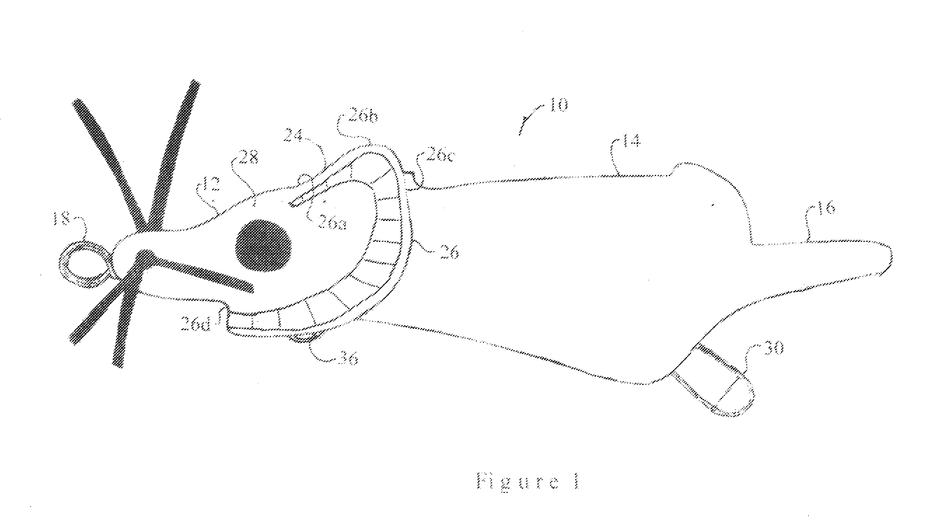

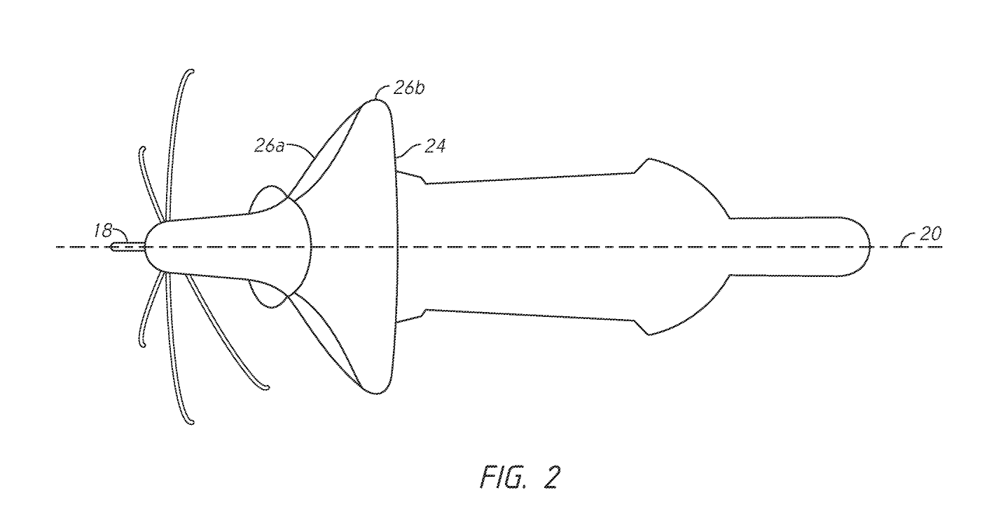

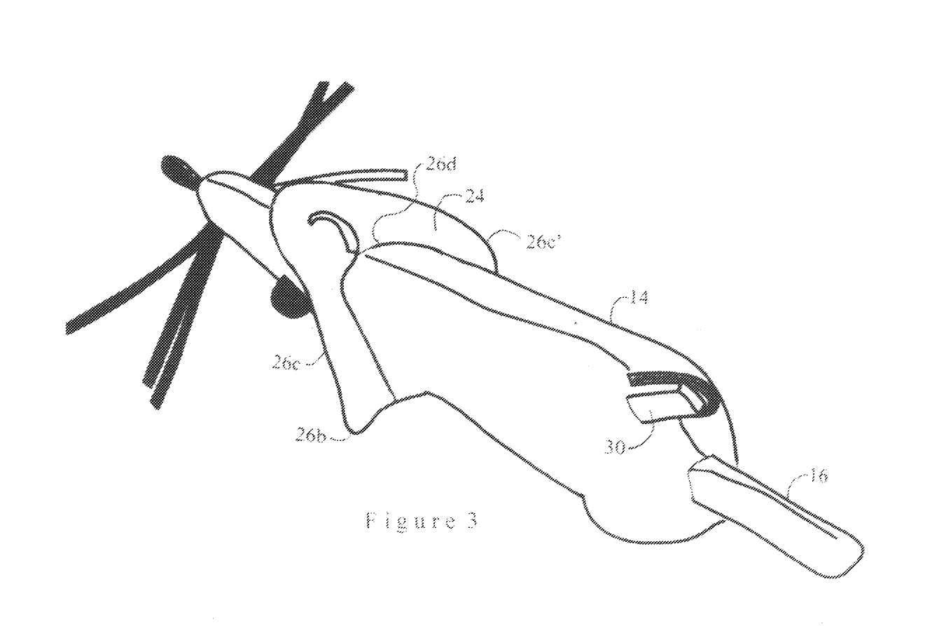

With reference to the FIGS. 1-3, the lure of my invention, generally 10, is in the shape of a rodent such as a mouse or chipmunk. The rodent has a head 12, a body 14 and a tail 16. The lure is buoyant and is drawn along the surface of a body of water, head first, by a fishing line (not illustrated) attached to a ring 18 at die nose of the rodent. The line is accordingly attached to the leading edge of the rodent. The longitudinal axis 20-20 of the lure coincides with the direction of travel of the rodent as it is being drawn through the water.

The rodent has a pair of ears 24, each of which is concave and has an outer margin 26 which is defined by an edge having a first segment 26a which commences at the forehead 28 and which extends downstream and upwardly and outwardly of the head to a second segment 26b. Segment 26b is generally semi-circular and it too is outwardly of the bead. The second segment terminates at a third segment 26c. The latter segment extends generally downwardly and upstream of the rodent's bead while remaining outward of the head throughout its length. Segment 26c terminates at a fourth segment 26d.

Fourth segment 26d is generally semi-circular and extends m an upstream end of the fourth segment 26c′ on the opposite sick of the rodent's body. Segment 26d is located beneath the rodent's head and is disposed outwardly of the head.

The ears are concave throughout their length and are adapted to scoop the water through which the lure is drawn and to cause the water to flow outwardly from the ears with resulting turbulence of the water through which the lure passes.

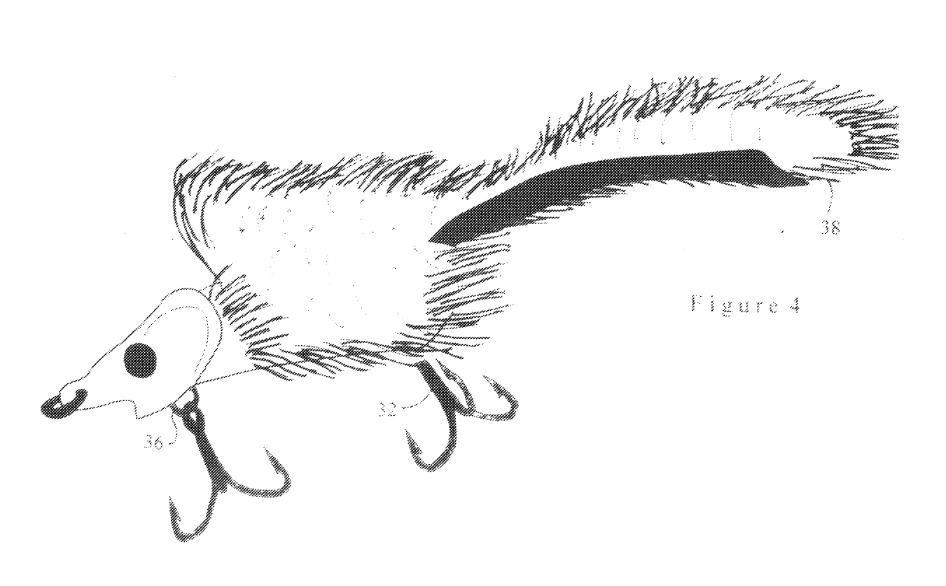

A nub 30 extends downwardly from the body of the rodent to which a hook 32 (illustrated in FIG. 4) may be attached. A hook may also be attached to ring 18 at the nose of the rodent and to a second ring 36 beneath the rodent's bead. Nub 30 is located far enough from the extension of tail 16, described below, to avoid fouling of hook 32 by a tad extension described below.

The weight of the lute is preferably adjusted such that the downstream end of the body travels slightly below the surface of water while the upstream end of the body travels along the surface of water. The tall and the extension to the tail preferably travels along the surface of water.

The body is preferably largely hollow so that noise-making means may located in the hollow interior. The noise maker may be metallic balls such as B-B's which are free to move into and out of contact with each other as the lure travels through wafer.

The preferable shape of the lure is a rodent but it can be in other shapes such as a fish, a newt or a salamander. As long as the lure has at least one of the features described above such as protruding ears or fur on its outer wall its shape is suitable.

Preferably the lure has a rough outer surface since such a surface produces more turbulence than a smooth surface as the lure travels through water. More preferable the lure has a furry outer coat as illustrated in FIG. 4 since such a coat produces significant turbulence. Not only does fur cause turbulence, but it tends to undulate in the way a furry rodent does as it swims through water. A furry lure is more life-like than, one without fur and is attractive to fish for this mason. The fur of rabbits is preferable because it is readably accessible but muskrat fur, while not usually as readily accessible, is also suitable.

With reference again to FIG. 4, an extension 38 is preferably attached to tail 16. The extension consists of a narrow strip of fur which is flexible so that it undulates as the lure travels through water.

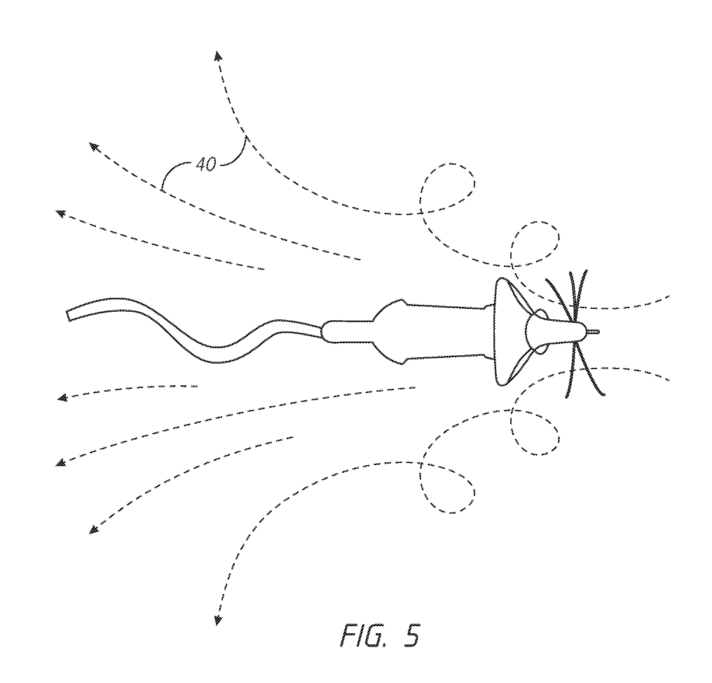

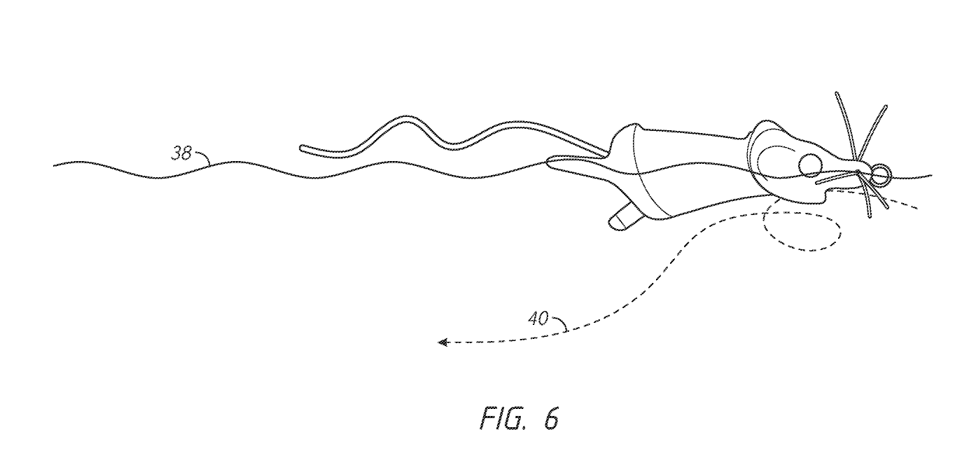

With reference to FIGS. 5 and 6, as the lure is drawn along the surface 38 of water, currents are generated which flow generally in the direction of the broken lines 40. Turbulence also occurs in the wash and wake of the lure by virtue of the shape of the rodent's ears. The turbulence causes bubbles to form in the water and the bubbles arouse the curiosity offish in the vicinity of the lure.

It will be understood, of course, that modifications can be made in the lure of the invention without departing from the scope and purview of the invention as defined in the appended claims.

1. A buoyant fishing lure adapted to be drawn along the surface of water, said lure being in the shape of a rodent or other small creature, said lure having a head at the upstream end of said lure and a body and tail at the downstream end of said lure, said head having a pair of ears each being defined by an edge consisting of a first segment which commences at a forehead of said head and which extends downstream and both upwardly and outwardly of said head and terminates at a second segment of said edge, said second segment being generally semi-circular and extending outwardly of said head to a third segment which extends outwardly of said head and generally downwardly and upstream and terminating at a fourth segment, said fourth segment being generally semi-circular and extending outwardly beneath said head to an upstream end of a fourth segment at the other said ear, said ears being concave throughout their length and adapted to scoop the water through which said lure is drawn and causing the water to flow outwardly from said ears with resulting turbulence of the water through which said lure passes.

2. The lure of claim 1 including a weight, the location of which being adjusted in said body such that the lure travels along the surface of water.

3. The lure of claim 1 including a weight, the location of which is adjusted such that said tail travels along the surface of water and said body travels beneath the surface of water.

4. The lure of claim 1 further including means for producing a noise as said lure travels through water.

5. The lure of claim 4 wherein said noise producing means is a plurality of metallic balls disposed within said body and free to move into and out of contact with each other as said lure travels through water.

6. The lure of claim 1 wherein said body has a rough outer surface.

7. The lure of claim 1 wherein said body is covered in fur.

8. The lure of claim 1 further including a nub disposed beneath said body to which a hook is attached, said nub being located far enough from said tail to avoid fouling of said hook by said tail.

9. The lure of claim 1 further including a tail attached to a downstream end of said body, said tail being composed of a strip of fur.

10. The lure of claim 7 wherein said fur is rabbit fur.

11. A buoyant fishing lure adapted to be drawn along the surface of water, said lure being in the shape of a rodent or other small creature, said lure having a body provided with a coat of fur which covers at least part of said body, said fur causing water through which said lure travels to flow outwardly from said body and bubbles to form in the wake and wash of said body.

12. The lure of claim 11 further including a tail extension attached to a downstream end of said body said tail extension being composed of a strip of fur.

13. The lure of claim 11 including a weight, the location of which being adjusted in said body such that the downstream end of said body travels beneath the surface of water while the upstream end of said body travels along the surface of water.

14. The lure of claim 12 wherein the weight of said tail is adjusted such that said tail extension travels along the surface of water.

15. The lure of claim 11 further including means for producing a noise as said lure travels through water.

16. The lure of claim 15 wherein said noise producing means is a plurality of metallic balls disposed within said body and free to move into and out of contact with each other as said lure travels through water.

17. The lure of claim 12 further including a nub disposed beneath said body to which a hook is attached, said nub being located far enough from said tail to avoid fouling of said hook by said tail extension.

18. The lure of claim 11 wherein said fur is composed of the fur of a rabbit.
